(19) United States
(12) Patent Application Publication
(10) Pub. No.: US 2013/0099769 A1
(43) Pub. Date: Apr. 25, 2013

(54) Current source circuit with high order temperature compensation and current source system thereof

(71) Applicant: Fangping Fan, Chengdu (CN)

(72) Inventor: Fangping Fan, Chengdu (CN)

(73) Assignee: IPGoal Microelectronics (Sichuan) Co., Ltd.

(21) Appl. No.: 13/494,029

(22) Filed: Jun. 12, 2012

(30) Foreign Application Priority Data
Oct. 19, 2011 (CN) 201110317652.4

(51) Int. Cl. G05F 3/16

(52) U.S. Cl. 323/312

(57) ABSTRACT

A current source circuit with high order temperature compensation, includes a reference voltage terminal, a first power module, a second power module, a control module, a current source output module and a bias current source module. The control module includes a first field-effect tube (FET), a second FET, and a third FET. The bias current source module includes a first bias current source and a second bias current source. The current source output module includes a fourth FET, a fifth FET, and an output terminal. The first power module includes a first comparator, a sixth FET, a first resistor and a second resistor. The second power module includes a second comparator, a seventh FET, a third resistor, and a fourth resistor. A current source system with high order temperature compensation is further provided.

### BACKGROUND OF THE PRESENT INVENTION

1. Field of Invention

The present invention relates to a current source circuit and a current source system, and more particularly to a current source circuit with high order temperature compensation and having a simple structure, and a current source system thereof.

2. Description of Related Arts

A bandgap reference circuit utilizes a sum of a voltage in proportion to the temperature and a diode drop, wherein temperature coefficients of the voltage and the diode drop are canceled out, in such a manner that a reference voltage independent of the temperature is achieved. The reference voltage thereof is similar to a bandgap of silicon, so the reference voltage is called bandgap reference. A current source circuit adopts a bandgap reference circuit to generate a current source, which causes a big area and a complex structure thereof, and increases a cost of a chip thereof. Moreover, the current source generated by the bandgap reference circuit changes greatly with changing of the temperature.

FIG. 1 is a conventional current source circuit with a first order temperature compensation. The current source circuit comprises a first field effect tube (FET) M1, a second FET M2, a third FET M3, a fourth FET M4, a fifth FET M5, a first bias current source I1, a second bias current source 12, and an output terminal Vout. According to the current source circuit, it is deduced that the fourth FET M4 is working in a sub-threshold region, and a current that flows through the fourth FET M4 is I44, I44=I0*e^{VGS/VTH}=I0*e^{VTH/VT}, wherein I0 is a constant, VGS is a gate-source voltage of an FET, VT=KT/q, wherein k and q are physical constants, T is a temperature. Because a threshold voltage VTH is in inverse proportion to the temperature T, it is known that temperature coefficients in VTH/VT can be cancelled out, i.e., the first order temperature compensation is accomplished, thus I44=I0*e^{a} is obtained; wherein the symbol “a” is a parameter without a first order temperature characteristic. In order to minimize a variation that the current source generated changes with the temperature, it is necessary to provide a current source circuit with high order temperature compensation and a current source system thereof.

### SUMMARY OF THE PRESENT INVENTION

In view of the descriptions mentioned above, it is necessary to provide a current source circuit with high order temperature compensation and having a simple structure, and a current source system thereof.

A current source circuit with high order temperature compensation, comprises a reference voltage terminal, a first power module connected with the reference voltage terminal, a second power module connected with the reference voltage terminal, a control module connected with the second power module, a current source output module connected with the first power module and the control module, and a bias current source module connected with the second power module, the control module and the current source output module, wherein the control module comprises a first field effect tube (FET), a second FET connected with the first FET, and a third FET connected with the second FET; the bias current source module comprises a first bias current source connected with the second FET, and a second bias current source connected with the third FET; the current source output module comprises a fourth FET connected with the third FET and the second bias current source, a fifth FET connected with the fourth FET, and an output terminal connected with the fifth FET; the first power module comprises a first comparator connected with the reference voltage terminal, a sixth FET connected with the first comparator and the fourth FET, a first resistor connected with the sixth FET, and a second resistor connected with the first resistor; the second power module comprises a second comparator connected with the reference voltage terminal, a seventh FET connected with the second comparator, the first FET and the second bias current source, a third resistor connected with the seventh FET, and a fourth resistor connected with the third resistor.

A current source system with high order temperature compensation, comprises a reference voltage terminal, a first power module connected with the reference voltage terminal, a second power module connected with the reference voltage terminal, a control module connected with the second power module for providing the current source system with a temperature compensation, a current source output module connected with the first power module and the control module for generating a current source, and a bias current source module connected with the second power module, the control module, and the current source output module for providing the current source with an operating current required.

Compared with the prior art, the current source circuit with high order temperature compensation and current source system thereof according to preferred embodiments of the present invention are capable of generating a current source having a high-temperature characteristic without adopting of a bandgap reference circuit, have simple structures, and are easy to implement.

These and other objectives, features, and advantages of the present invention will become apparent from the following detailed description, the accompanying drawings, and the appended claims.

### BRIEF DESCRIPTION OF THE DRAWINGS

FIG. 1 is a circuit diagram of a conventional current source circuit with first order temperature compensation.

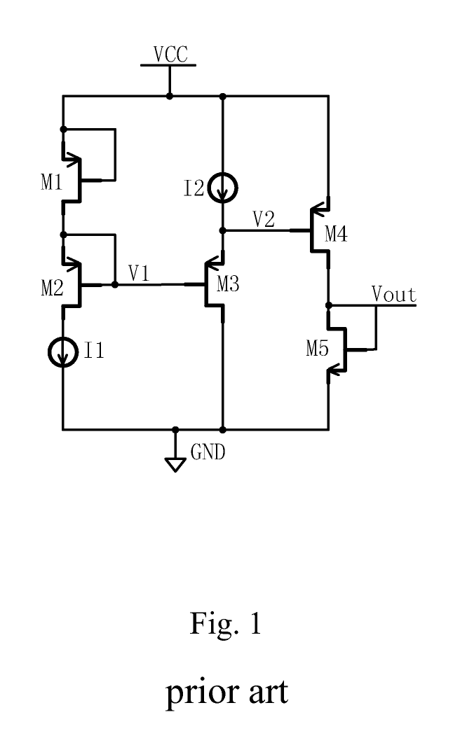

FIG. 2 is a block diagram of a current source system with high order temperature compensation according to a preferred embodiment of the present invention.

FIG. 3 is a circuit diagram of a current source circuit with high order temperature compensation according to a preferred embodiment of the present invention.

### DETAILED DESCRIPTION OF THE PREFERRED EMBODIMENT

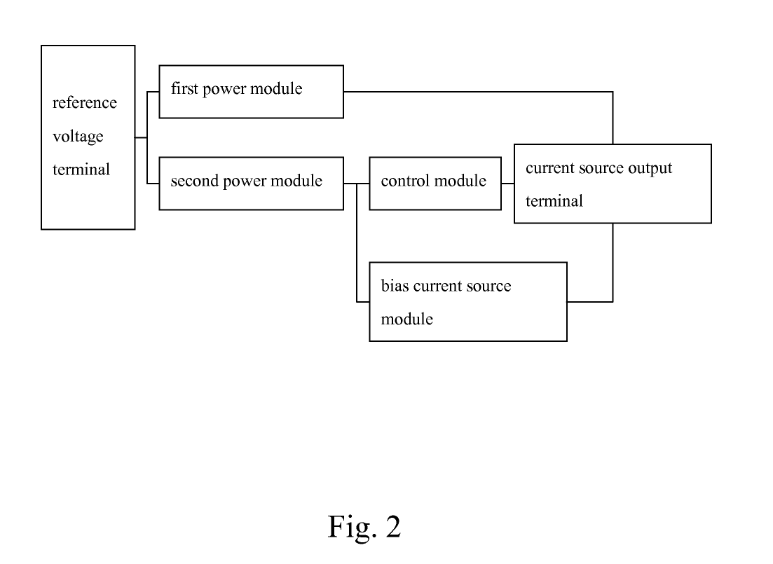

Referring to FIG. 2 of the drawings, according to a preferred embodiment of the present invention, a current source system with high order temperature compensation comprises a reference voltage terminal, a first power module connected with the reference voltage terminal, a second power module connected with the reference voltage terminal, a control module connected with the second power module, a current source output module connected with the first power module and the control module, and a bias current source module connected with the second power module, the control module and the current source output module.

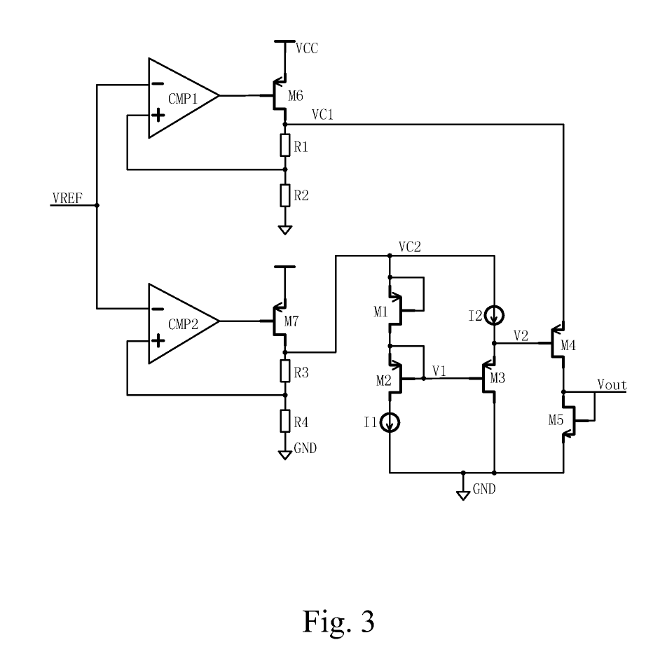

Further referring to FIG. 3, a circuit diagram of a current source circuit with high order temperature compensation according to a preferred embodiment of the present invention is illustrated, wherein the control module comprises a first FET M1, a second FET M2, and a third FET M3; the bias current source module comprises a first bias current source I1 and a second bias current source 12; the current source output module comprises a fourth FET M4, a fifth FET M5, and an output terminal Vout; the first power module comprises a first comparator CMP1, a sixth FET M6, a first resistor R1, and a second resistor R2; the second power module comprises a second comparator CMP2, a seventh FET M7, a third resistor R3, and a fourth resistor R4.

The reference voltage terminal is for inputting a reference voltage VREF to the first power module and the second power module; the first power module is for providing the current source output module with a voltage VC1 having a first order positive temperature characteristic; the second power module is for providing the control module with a voltage VC2 having a first order positive temperature characteristic; the control module is for providing temperature compensation to the current source system having high order temperature compensation, in such a manner that a current source generated hardly changes with the temperature; the bias current source module is for supplying an operating current required to the current source system with high order temperature compensation; and the current source output module is for generating the current source.

According to the preferred embodiment of the present invention, connections of the current source circuit with high order temperature compensation are as follows. Both an inverting input terminal of the first comparator CMP1 and an inverting terminal of the second comparator CMP2 are connected with the reference voltage terminal, so as to receive the reference voltage VREF input by the reference voltage terminal. A non-inverting terminal of the first comparator CMP1 is connected with both a first terminal of the first resistor R1 and a first terminal of the second resistor R2, a non-inverting terminal of the second comparator CMP2 is connected with a first terminal of the third resistor R3 and a first terminal of the fourth resistor R4. A gate electrode of the sixth FET M6 is connected with an output terminal of the first comparator CMP1, a gate electrode of the seventh FET M7 is connected with an output terminal of the second comparator CMP2. A source electrode of the sixth FET M6 is connected with a source electrode of the seventh FET M7 and a power terminal VCC, a drain electrode of the sixth FET M6 is connected with a second terminal of the first resistor R1 and a source electrode of the fourth FET M4, a drain electrode of the seventh FET M7 is connected with a second terminal of the third resistor R3, a gate electrode of the first FET M1, a source electrode of the first FET M1, and a first terminal of the second bias current source 12. A gate electrode of the second FET M2, a source electrode of the second FET M2, and a gate electrode of the third FET M3 are all connected with a drain electrode of the first FET M1, a drain electrode of the second FET M2 is connected with a first terminal of the first bias current source I1. A source electrode of the third FET M3 is connected with a second terminal of the second bias current source I2 and a gate electrode of the fourth FET M4, a drain electrode of the fourth FET M4, a gate electrode of the fifth FET M5, and a drain electrode of the fifth FET M5 are all connected with the output terminal Vout. A second terminal of the first bias current source I1, a drain electrode of the third FET M3, a source electrode of the fifth FET M5, a second terminal of the second resistor R2 and a second terminal of the fourth resistor R4 are all connected with a ground terminal GND

Working principles of the current source circuit with high order temperature compensation and the current source system thereof according to preferred embodiments of the present invention are as follows.

Firstly, the first FET M1, the second FET M2, and the third FET are set to be equal in length and width, and a channel length L of the fourth FET M4 is equal to channel lengths of the first FET M1, the second FET M2, and the third FET M3, so as to ensure that the first FET M1, the second FET M2, the third FET M3, and the fourth FET M4 all have an equal threshold voltage.

It is known from a circuit diagram shown in FIG. 2 that:

V1=VC2−VGS1−VGS2;

V2=V1+VGS3=VC2−VGS1−VGS2+VGS3;

further because

VGS1=VTH+(2*I11*K1/(W/L)₁)^{0.5};

VGS2=VTH+(2*I22*K1/(W/L)₂)^{0.5}; and

VGS3=VTH+(2*I33*K1/(W/L)₃)^{0.5};

wherein VGS1, VGS2, and VGS3 are respectively gate-source voltages of the first FET M1, the second FET M2, and the third FET M3, K1 is a process constant, K1=μn*Cox,μn is an electron mobility, Cox is a gate oxide thickness of an FET process, VTH is a threshold voltage of an FET, I11, I22 and I33 are respectively currents that flow through the first FET M1, the second FET M2 and the third FET M3, (W/L)₁, (W/L)₂, and (W/L)₃ are respectively breadth length ratios of the first FET M1, the second FET M2 and the third FET M3,

it is obtained that:

V2=VC2−(VTH+(2*I11*K1/(W/L)₁)^{0.5}−(VTH+(2*I22*K1/(W/L)₂)^{0.5})+(VTH+(2*I33*K1/(W/L)₃)^{0.5});

wherein I11=I22=I1=I,I33=I2=4I, (W/L)₁=(W/L)₂=(W/L)₃,

so

V2=VC2−VTH;

accordingly, a gate-source voltage of the fourth FET M4 is VGS4, VGS4=VC1−VC2+VTH;

it is set that VC1>VC2, and VREF=aT+b, wherein both a and b are constants, i.e., the reference voltage VREF is linear with the temperature T, so:

VC1=VREF*(R1+R2)/R2=(aT+b)*(R1+R2)/R2; and

VC2=VREF*(R3+R4)/R4=(aT+b)*(R3+R4)/R4;

so the fourth FET M4 is working in a saturation region, and a current that flows through the fourth FET M4 is I44,

$$\begin{matrix}I 44 = μ n * Cox * {( W / L )}_{4} * {( VGS 4 - VTH )}^{2} / 2 \\ = μ n * Cox * {( W / L )}_{4} * {( VC 1 - VC 2 )}^{2} / 2 ;\end{matrix} \qquad ( 1 ) ,$$

if (R1+R2)/R2=α, (R3+R4)/R4=β, wherein both α and β are proportional coefficients,

VC1−VC2=(aT+b)*(α−β) (2),

putting the equation (2) into the equation (1), it is obtained that:

I44=μn*Cox*(W/L)₄*(aT+b)²*(α−β)²/2;
further because μn=μ0*T^{-3/2}, wherein μ0 is a physical constant,

a derivative of I44 is calculated with respect to T, it is obtained that:

∂I44/∂T=μ0*Cox*(W/L)₄*T^{-5/2}(α−β)²*(aT+b)*(aT−3b)/4.

It is known from the above equation that a value thereof is very small, i.e., a temperature coefficient of a current generated by the current source circuit with high order temperature compensation or the current system thereof is very small.

The current that flows through the fourth FET M4 is the current source generated by the current source circuit and system with high order temperature compensation according to a preferred embodiment of the present invention, so structures of the current source circuit and system according to preferred embodiments of the present invention provide high order temperature compensation for the current source output.

The current source circuit with high order temperature compensation and the current source system thereof according to preferred embodiments of the present invention are capable of generating a current source having a low temperature coefficient. It is verified that a variation of the current output thereby is approximately 3% in a full temperature range from −40° C. to 125° C. It can be seen from the descriptions mentioned above that the current source circuit with high order temperature compensation and the current source system thereof according to preferred embodiments of the present invention are capable of generating a high-temperature characteristic current source without a bandgap reference circuit, have simple structures and are easy to control.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A current source circuit with high order temperature compensation, comprising a reference voltage terminal, a first power module connected with said reference voltage terminal, a second power module connected with said reference voltage terminal, a control module connected with said second power module, a current source output module connected with said first power module and said control module, and a bias current source module connected with said second power module, said control module and said current source output module, wherein said control module comprises a first field effect tube (FET), a second FET connected with said first FET, and a third FET connected with said second FET; said bias current source module comprises a first bias current source connected with said second FET, and a second bias current source connected with said third FET; said power source output module comprises a fourth FET connected with said third FET and said second bias current source, a fifth FET connected with said fourth FET, and an output terminal connected with said fifth FET; said first power module comprises a first comparator connected with said reference voltage terminal, a sixth FET connected with said first comparator and said fourth FET, a first resistor connected with said sixth FET, and a second resistor connected with said first resistor; said second power module comprises a second comparator connected with said reference voltage terminal, a seventh FET connected with said second comparator, said first FET and said second bias current source, a third resistor connected with said seventh FET, and a fourth resistor connected with said third resistor.

2. The current source circuit with high order temperature compensation, as recited in claim 1, wherein both an inverting input terminal of said first comparator and an inverting terminal of said second comparator are connected with said reference voltage terminal, a non-inverting terminal of said first comparator is connected with a first terminal of said first resistor and a first terminal of said second resistor, a non-inverting terminal of said second comparator is connected with a first terminal of said third resistor and a first terminal of said fourth resistor.

3. The current source circuit with high order temperature compensation, as recited in claim 2, wherein a gate electrode of said sixth FET is connected with an output terminal of said first comparator, a gate electrode of said seventh FET is connected with an output terminal of said second comparator, a source electrode of said sixth FET is connected with a source electrode of said seventh FET and a power terminal, a drain electrode of said sixth FET is connected with a second terminal of said first resistor and a source electrode of said fourth FET, a drain electrode of said seventh FET is connected with a second terminal of said third resistor, a gate electrode of said first FET, a source electrode of said first FET, and a first terminal of said second bias current source.

4. The current source circuit with high order temperature compensation, as recited in claim 3, wherein a gate electrode of said second FET, a source electrode of said second FET, and a gate electrode of said third FET are all connected with a drain electrode of said first FET, a drain electrode of said second FET is connected with a first terminal of said first bias current source.

5. The current source circuit with high order temperature compensation, as recited in claim 4, wherein a source electrode of said third FET is connected with a second terminal of said second bias current source and a gate electrode of said fourth FET, a drain electrode of said fourth FET, a gate electrode of said fifth FET, and a drain electrode of said fifth FET are all connected with said output terminal.

6. The current source circuit with high order temperature compensation, as recited in claim 5, wherein a second terminal of said first bias current source, a drain electrode of said third FET, a source electrode of said fifth FET, a second terminal of said second resistor and a second terminal of said fourth resistor are all connected with a ground terminal.

7. A current source system with high order temperature compensation, comprising a reference voltage terminal, a first power module connected with said reference voltage terminal, a second power module connected with said reference voltage terminal, a control module connected with said second power module for providing said current source system with temperature compensation, a current source output module connected with said first power module and said control module for generating a current source, and a bias current source module connected with said second power module, said control module, and said current source output module for providing said current source with an operating current required.

8. The current source system with high order temperature compensation, as recited in claim 7, wherein said control module comprises a first field effect tube (FET), a second FET connected with said first FET, and a third FET connected with said second FET; said bias current source module comprises a first bias current source connected with said second FET, and a second bias current source connected with said third FET; said power source output module comprises a fourth FET connected with said third FET and said second bias current source, a fifth FET connected with said fourth FET, and an output terminal connected with said fifth FET.

9. The current source system with high order temperature compensation, as recited in claim 8, wherein said first power module comprises a first comparator connected with said reference voltage terminal, a sixth FET connected with said first comparator and said fourth FET, a first resistor connected with said sixth FET, and a second resistor connected with said first resistor.

10. The current source system with high order temperature compensation, as recited in claim 9, wherein said second power module comprises a second comparator connected with said reference voltage terminal, a seventh FET connected with said second comparator, said first FET and said second bias current source, a third resistor connected with said seventh FET, and a fourth resistor connected with said third resistor.
